(19) United States
(12) Patent Application Publication
(10) Pub. No.: US 2006/0224779 A1
(43) Pub. Date: Oct. 5, 2006

(54) Slim type remote control

(75) Inventors: Wen-Hsien Lu, Yonghe City (TW); Jung-Chin Chang, Yonghe City (TW)

Correspondence Address: BACON & THOMAS, PLLC, 625 SLATERS LANE, FOURTH FLOOR, ALEXANDRIA, VA, 22314, US

(73) Assignee: FORMOSA21 INC., Chung Ho City (TW)

(21) Appl. No.: 11/191,917

(22) Filed: Jul. 29, 2005

(30) Foreign Application Priority Data
Mar. 30, 2005 (TW) 094204887

(51) Int. Cl. G06F 3/00

(52) U.S. Cl. 710/8

(57) ABSTRACT

The slim type remote control of the present invention can have the size of a standard-sized PCMCIA Express card, and so the slim type remote control can be inserted into a PCMCIA Express slot of the notebook computer. Therefore, the present invention utilizes the key set to wirelessly control the notebook computer to control the operating system or to support multimedia programs and functions. Accordingly, user can use the wireless signal receiving module and the confirmation device to confirm the confirmation signal has been received by the notebook computer, or verify that signal has been sent by the notebook computer. Therefore, the wireless receiving module and the confirmation device user can use the confirmation device to confirm that a command has been received by the notebook computer, or verify that a signal has been sent by the notebook computer.

### BACKGROUND OF THE INVENTION

1. Field of the Invention

The present invention relates to a slim type remote control and, more particularly, to a slim type remote control is conformed to a standard-sized PCMCIA Express card.

2. Description of the Related Art

With technological improvements, portable notebook computers have gradually replaced traditional personal computers. As notebook computers have been developed to support various functionalities, special remotes for notebook computers have also been developed.

However, standard remotes for notebook computers are large in size, and so cannot be attached onto the notebook computer. As a result, there is no proper storage space for these remotes. Furthermore, the typical remote for a notebook computer does not have a laser pointer, and so the user must use an extra laser pen in meetings or presentations. Moreover, new notebook computers are used not only for data editing purposes, but also for multimedia purposes; however, the standard remote for the notebook computer does not have multimedia support, which is very inconvenient for the user.

Therefore, it is desirable to provide a slim type remote control with a laser pointer for a notebook computer to mitigate and/or obviate the aforementioned problems.

### SUMMARY OF THE INVENTION

The slim type remote control of the present invention comprises a thin case, a wireless signal transmitting module, a power device, a control circuit board and a key set. The thin case is conformed to a standard-sized PCMCIA Express card in periphery, the thin case further comprising an inner space therein, a top face and a front side edge, the front side edge having a wireless signal transmitting opening. The wireless signal transmitting module comprises a wireless signal remote transmitting source, the wireless signal transmitting module being received inside the inner space of the thin case, and the wireless signal remote transmitting source correspondingly aligned with the wireless signal transmitting opening. The power device is received inside the inner space of the thin case. The control circuit board is disposed within the inner space of the thin case, the control circuit board being electrically connected to the wireless signal transmitting module, and the power device. The key set electrically connected to the control circuit board and mounted on the top face of the thin case, the key set comprising a plurality of control buttons. The slim type remote control of the present invention can have the size of a standard-sized PCMCIA card, and so the slim type remote control can be inserted into a PCMCIA slot of the notebook computer. Therefore, the user can remove the slim type remote control from the slot and use it as both a remote and a laser pen, or insert it back into the PCMCIA slot for storage. Accordingly, the present invention utilizes the key set to wirelessly control the notebook computer to control the operating system or to support multimedia programs and functions. Furthermore, the present invention provides the laser module to replace a laser pen.

The wireless signal-transmitting module comprises an infrared light-transmitting module, or utilize RF, sonic, Bluetooth, or 802.11 series technologies for the wireless transmission protocol.

Furthermore, the inner space of the thin case further accommodates a wireless signal receiving module and a confirming device, the wireless signal receiving module and the confirmation device respectively electrically connected to the control circuit board, the control circuit board controlling the wireless signal receiving module to receive an external wireless signal and controlling the confirmation device to output a corresponding confirmation signal. Therefore, user can use the wireless signal receiving module and the confirmation device to confirm the confirmation signal has been received by the notebook computer, or verify that signal has been sent by the notebook computer.

Moreover, the inner space of the thin case further accommodates a cursor control module electrically connected to the control circuit board. The cursor control module is preferably a touch wheel pad, which can control the cursor so that the user does not need to add a mouse to control the cursor. The front side edge of the thin case has a laser light projection aperture, and the inner space of the thin case further accommodates a laser module electrically connected to the control circuit board. The laser module comprises a laser light source is correspondingly aligned with the laser light projection aperture. Hence, the user can use the laser light projected from the laser light projection aperture to point data during a conference.

Other objects, advantages, and novel features of the invention will become more apparent from the following detailed description when taken in conjunction with the accompanying drawings.

### BRIEF DESCRIPTION OF THE DRAWINGS

FIG. 1 is a perspective exploded view of a preferred embodiment according to the present invention.

FIG. 2 is a perspective view of the preferred embodiment according to the present invention.

FIG. 3 is a schematic view of the preferred embodiment according to the present invention.

FIG. 4 illustrates the present invention applied with a notebook computer.

FIG. 5 is a perspective view of the preferred embodiment according to the present invention.

### DETAILED DESCRIPTION OF THE PREFERRED EMBODIMENT

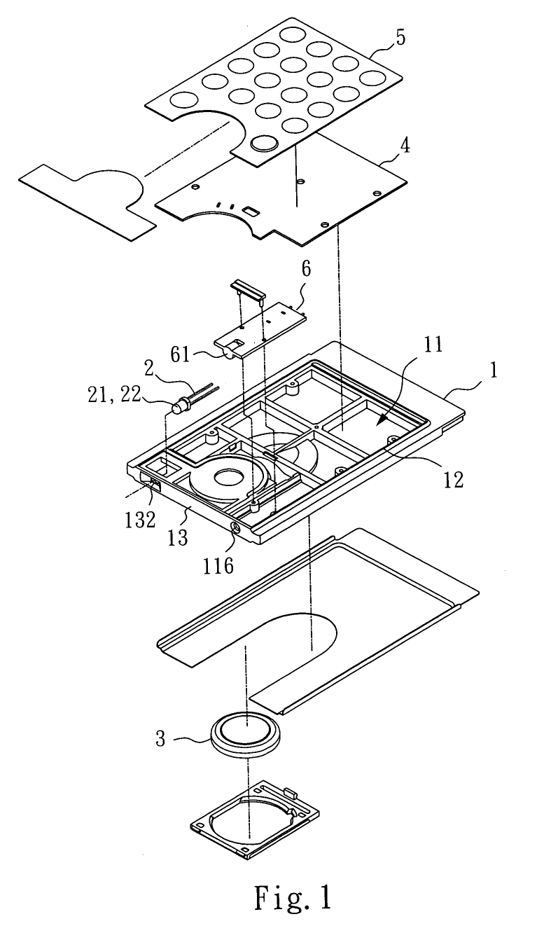

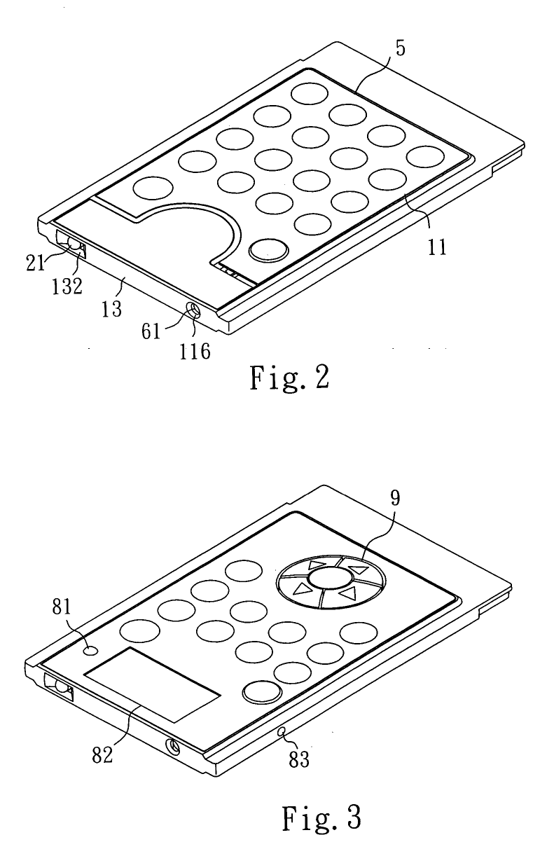

Please refer to FIG. 1 and FIG. 2. FIG. 1 is a perspective exploded view of a preferred embodiment according to the present invention. FIG. 2 is a perspective view of the preferred embodiment according to the present invention. The slim type remote control of the present invention comprises a thin case 1, a wireless signal transmitting module 2, a power device 3, a control circuit board 4, and a key set 5. In this embodiment, the slim type remote control is conformed to a standard-sized PCMCIA Express card 34 in periphery; the thin case 1 has an inner space 11 therein, a top face 12 and a front side edge 13, and the front side edge 13 has a wireless signal transmitting opening 132.

The wireless signal transmitting module 2 comprises a wireless signal remote transmitting source 21; the wireless signal transmitting module 2 is being received inside the inner space 11 of the thin case 1, and the wireless signal remote transmitting source 21 is correspondingly aligned with wireless signal transmitting opening 132. In this embodiment, the wireless signal-transmitting module 2 is an infrared light transmitting module, and the wireless signal remote transmitting source 21 is an LED so that the user can remotely control a notebook computer via infrared light transmission. Furthermore, the front side edge 13 of the thin case 1 has a laser light projection aperture 116, and the inner space 11 of the thin case 1 further accommodates a laser module 6 electrically connected to the control circuit board 4, and the laser module 6 comprises a laser light source 61 correspondingly aligned with the laser light projection aperture 116. Hence, the user can use the laser light projected from the laser light projection aperture 116 to point data during a conference.

The power device 3 is received inside the inner space 11 of the thin case 1. In this embodiment, the power device 3 is a Li battery, such as a CR2032 battery or any other equivalent battery. The control circuit board 4 is also received inside the inner space 11 of the thin case 1, and the control circuit board 4 is electrically connected to the laser module 6, the wireless signal transmitting module 2 and the power device 3. In this embodiment, the key set 5 is a membrane switch, which can reduce size. The membrane switch is also electrically connected to the control circuit board 4 and is placed on the top face 12 of the thin case 1. The key set 5 further comprises a laser light switch button 61 and a plurality of control buttons 62. The user may use the laser light switch button 61 to control the laser light source 21, and the plurality of control buttons 62 to control the notebook computer to utilize an operating system (OS) or change the settings of the OS (such as Windows). The control signals can be setup to correspond to multimedia software, such as PowerPoint, to change a presentation page, or to provide support for other multimedia player programs in the notebook computer.

As shown in FIG. 3, the inner space 11 of the thin case 1 further accommodates a wireless signal receiving module 22 and a confirmation device 8, and both the wireless signal receiving module 22 and the confirmation device 8 are respectively electrically connected to the control circuit board 4. The control circuit board 4 can control the wireless signal-receiving module 22 to receive an external wireless signal, and control the confirmation device 8 to output a corresponding confirmation signal. In this embodiment, the confirmation device 8 is an LED 81, which can provide a confirmation signal as a single flash; the confirmation device 8 can also be an LCD display 82, which can display a confirmation signal when the wireless signal receiving module 22 receives an external wireless signal, or display a response signal from the notebook computer. The confirmation device 8 can also be a buzzer 83, or other alarm device, and when the wireless signal-receiving module 22 receives an external wireless signal, the buzzer 83 can inform the user that the wireless signal has been received.

In this embodiment, the inner space 11 of the thin case 1 further accommodates a cursor control module electrically connected to the control circuit board 4. The cursor control module is preferably a touch wheel pad 9, which can control the cursor so that the user does not need to add a mouse to control the cursor.

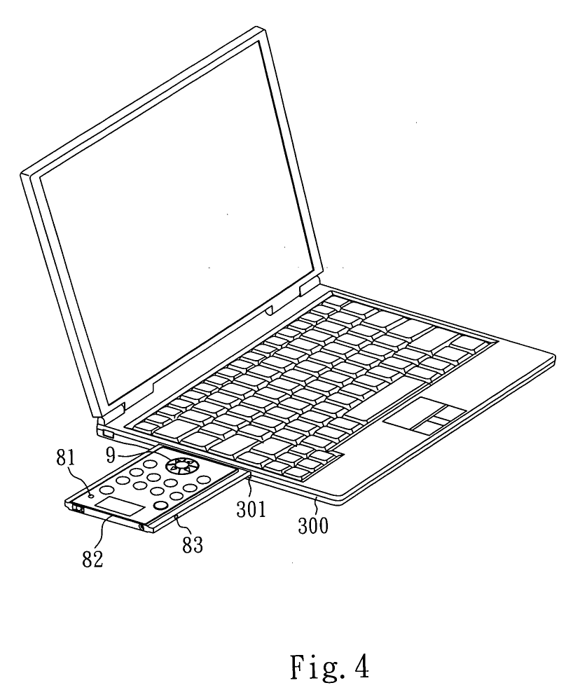

As shown in FIG. 4, the slim type remote control is conformed to a standard-sized PCMCIA card 34 in periphery, and so it can be inserted into a PCMCIA Express slot 301 of the notebook computer 300. The slim type remote control can be used as a remote, a laser pen, a cursor controller, or it can be stored in the PCMCIA Express slot 301.

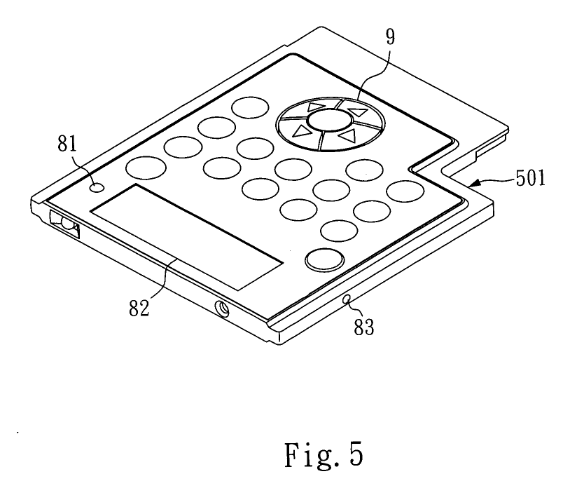

The slim type remote control of the present invention can also be conformed to a standard-sized PCMCIA card 54 in periphery. As shown in FIG. 5, the PCMCIA Express card 54 further comprises an extension part 501 that can be used for adding more buttons or for enlarging the LCD display 82. All other functionalities of the PCMCIA Express card 54 are similar to those of the PCMCIA Express card 34.

Accordingly, the present invention utilizes the key set to wirelessly control the notebook computer 300 to control the operating system or to support multimedia programs and functions. Furthermore, the present invention provides the laser module 6 to replace a laser pen. Furthermore, the slim type remote control utilizes the wireless receiving module to receive a signal sent from the notebook computer, and the user can use the confirmation device to confirm that a command has been received by the notebook computer, or verify that a signal has been sent by the notebook computer.

Although the present invention has been explained in relation to its preferred embodiment, it is to be understood that many other possible modifications and variations can be made without departing from the spirit and scope of the invention as hereinafter claimed.

What is claimed is:

1. A slim type remote control comprising:
a thin case having a standard PCMCIA Express card size in periphery, the thin case comprising an inner space therein, a top face and a front side edge, the front side edge having a wireless signal-transmitting opening;
a wireless signal-transmitting module comprising a wireless signal remote transmitting source, the wireless signal-transmitting module being received inside the inner space of the thin case and the wireless signal remote transmitting source being correspondingly aligned with the wireless signal-transmitting opening;
a power device received inside the inner space of the thin case;
a control circuit board received inside the inner space of the thin case, the control circuit board being electrically connected to the wireless signal transmitting module, and the power device; and
a key set electrically connected to the control circuit board and mounted on the top face of the thin case, the key set comprising a plurality of control buttons.

2. The slim type remote control as claimed in claim 1, wherein the wireless signal transmitting module comprising an infrared light-transmitting module.

3. The slim type remote control as claimed in claim 1, wherein the thin case is conformed to a standard-size of PCMCIA Express card of serial 34 in periphery.

4. The slim type remote control as claimed in claim 1, wherein the thin case is conformed to a standard-size of PCMCIA Express card of serial 54 in periphery.

5. The slim type remote control as claimed in claim 1, wherein the inner space of the thin case further accommodates a wireless signal receiving module and a confirming device, the wireless signal receiving module and the confirmation device respectively electrically connected to the control circuit board, the control circuit board controlling the wireless signal receiving module to receive an external wireless signal and controlling the confirmation device to output a corresponding confirmation signal.

6. The slim type remote control as claimed in claim 5, wherein the confirmation device comprises a light emitting diode.

7. The slim type remote control as claimed in claim 5, wherein the confirmation device comprises a liquid crystal display.

8. The slim type remote control as claimed in claim 5, wherein the confirmation device comprises a buzzer.

9. The slim type remote control as claimed in claim 1, wherein the inner space of the thin case further accommodates a cursor control module electrically connected to the control circuit board.

10. The slim type remote control as claimed in claim 9, wherein the cursor control module comprises a touch wheel pad.

11. The slim type remote control as claimed in claim 1, wherein the front side edge of the thin case further comprises a laser light projection aperture, the inner space of the thin case further accommodates a laser module electrically connected to the control circuit board, the laser module comprises a laser light source correspondingly aligned with the laser light projection aperture.

12. The slim type remote control as claimed in claim 1, wherein the key set comprises a membrane switch.

13. The slim type remote control as claimed in claim 1, wherein the power device is a Li battery.
